(19) United States
(12) Patent Application Publication
(10) Pub. No.: US 2009/0322982 A1
(43) Pub. Date: Dec. 31, 2009

(54) DIGITAL PICTURE FRAME WITH FLOATING LCD

(76) Inventor: Dean Finnegan, Dublin, CA (US)

Correspondence Address: Vierra Magen Marcus & DeNiro LLP, 575 Market Street, Suite 2500, San Francisco, CA, 94105, US

(21) Appl. No.: 12/490,210

(22) Filed: Jun. 23, 2009

Related U.S. Application Data
(60) Provisional application No. 61/075,263, filed on Jun. 24, 2008.

(51) Int. Cl. G02F 1/1333

(52) U.S. Cl. 349/58

(57) ABSTRACT

A digital media apparatus, such as a digital frame, includes a LCD display having a front surface, electrical components that are connected to the LCD to provide images on the LCD, a glass border surrounding the LCD display, and a frame surrounding the LCD display and the glass border. A first portion of the glass border is opaque in order to conceal the electrical components. A second portion of the glass border is clear. The second portion of the glass border surrounds the first portion of the glass border to provide a visual effect of the LCD and second portion floating within the digital media apparatus.

This application claims the benefit of U.S. Provisional Application No. 61/075,263, “Digital Picture Frame With Floating LCD,” by Dean Finnegan, filed on Jun. 24, 2008, incorporated herein by reference.

### BACKGROUND

With the increasing popularity of digital photography, digital picture frames have become a popular means of displaying digital photos. Typically, a digital picture frame includes a display such as a liquid crystal display (LCD) having a display screen encased in a plastic or wooden frame made to resemble a printed picture frame. The surrounding frame is attached to the outside of the display, and is positioned at the front of the display so as to resemble a conventional picture frame housing displaying a printed picture.

Frames include a variety of additional features, including the ability to play music or other media files. Controls are provided to control the presentation of media within the frame.

### SUMMARY

A digital media apparatus is disclosed. In one embodiment, the digital media apparatus is a digital picture frame.

### BRIEF DESCRIPTION OF THE DRAWINGS

FIG. 1 depicts a front view of the picture frame apparatus including the present technology.

FIG. 2 depicts a side rear view of the picture frame apparatus including the present technology.

FIG. 3 depicts a side rear view of the picture frame apparatus including the present technology.

FIG. 4 is a rear view of the picture frame apparatus.

FIG. 5 is a partial cut-away rear view of the frame apparatus.

FIG. 6 is a front view of a glass panel.

### DETAILED DESCRIPTION

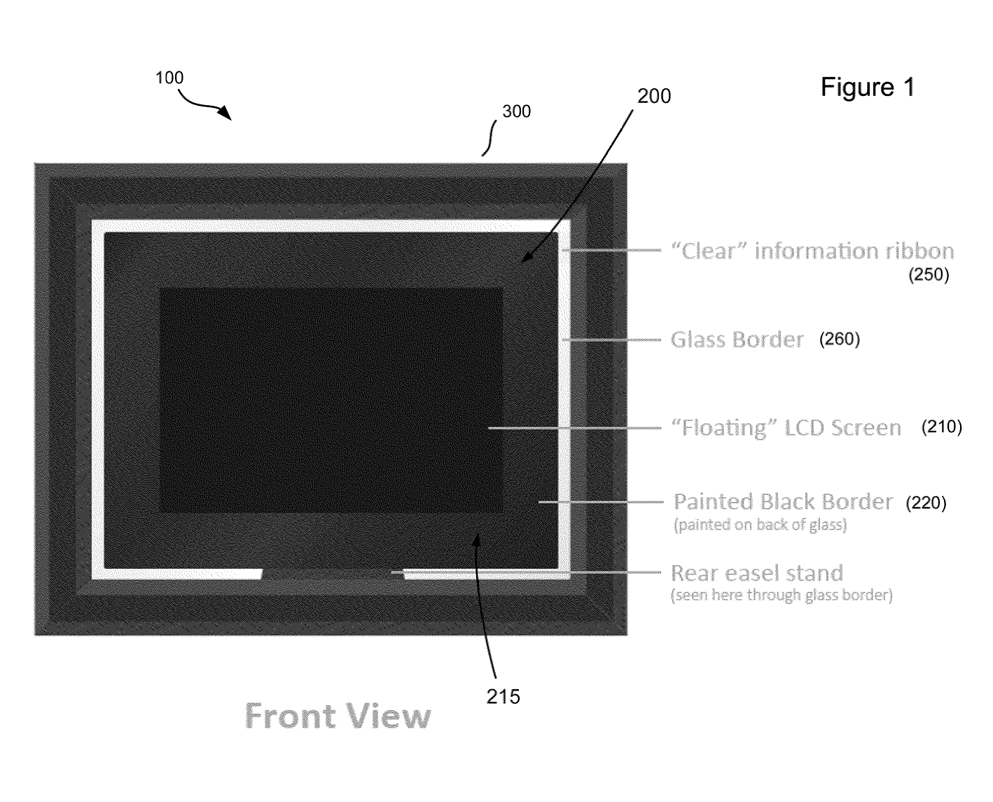

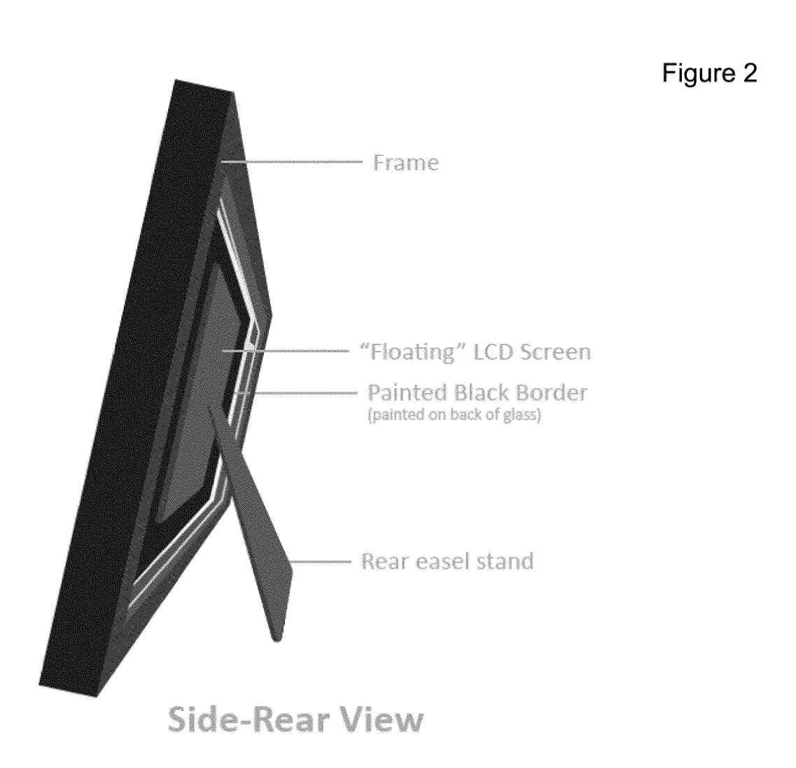

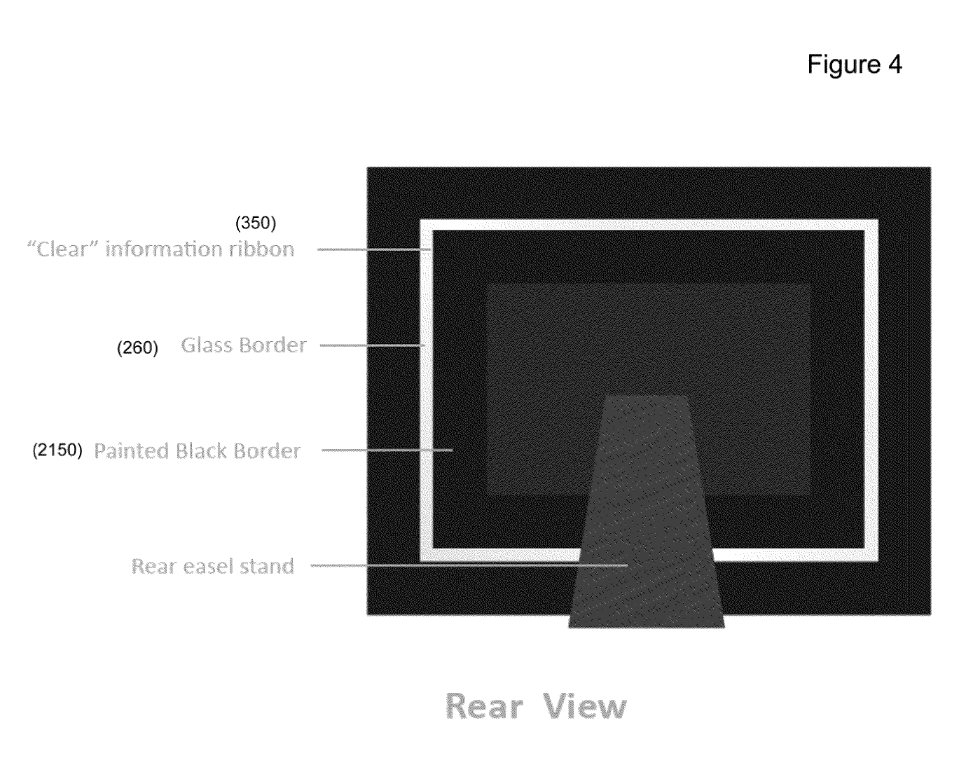

FIGS. 1-5 show an embodiment of the frame apparatus 100 which includes a display 200 surrounded by a frame element 300. In this embodiment, the frame element has a traditional wood appearance, but the frame element may take any shape or style and may be separate from the display 200, omitted entirely, or integrated therewith.

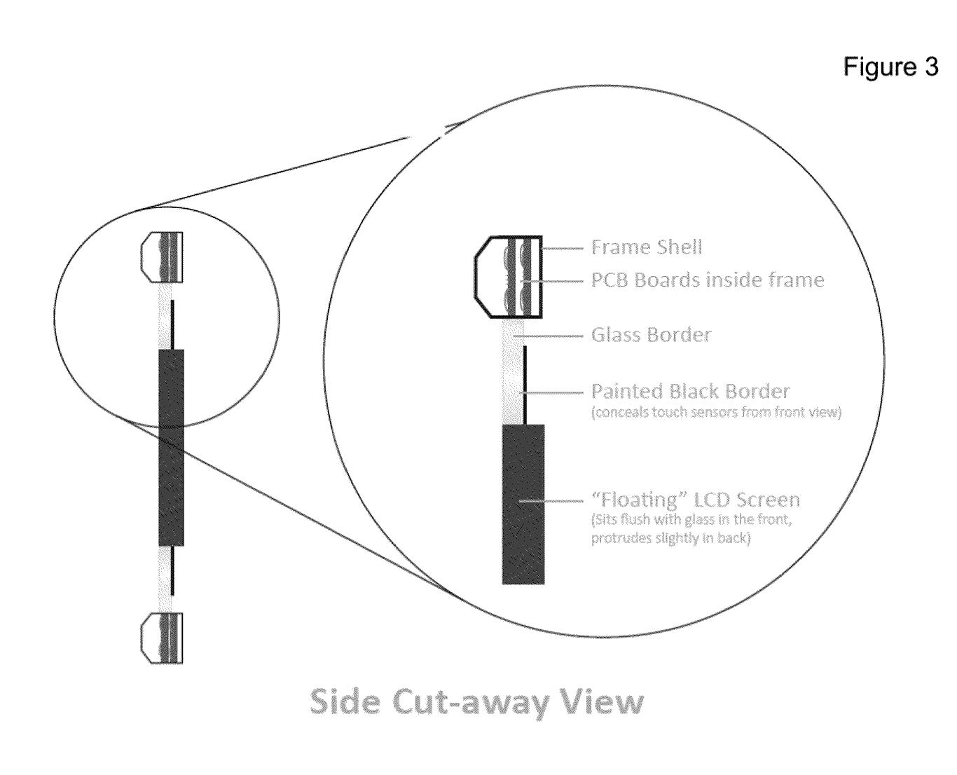

The display includes a floating LCD display 210 surrounded by a glass border 215. The LCD display is mounted in the glass border such that a front surface of the LCD display is flush with a front surface of the glass, as illustrated in FIG. 3. A portion of the glass border 215 is painted or otherwise provided with a black finish 220 in order to conceal elements of an information carrying conductor ribbon 350 coupled to the LCD display and a printed circuit board 310 mounted in the frame 300. The black finish 220 resembles a picture mat surrounding a display picture in the LCD. A clear glass portion 260 surrounds the black portion to provide a visual effect of the LCD and black portion “floating” within the frame element 300. The conductor ribbon 350 causes a plurality of electrical leads in a clear ribbon.

In one embodiment, the display 200 may also include circuitry and controls, to display and perform various types of media including images and movies on the face, and sounds via built in speakers (not shown). Circuitry is provided in the frame 300 on PCB board 310 to render display media on the face of the device. Such circuitry may include one or more microprocessors, logic circuits and memory as well as instructions directing the microprocessor to implement various media display functions. Such instructions may include providing a series of user menus and prompts providing the user with access to control a number of functions that the device can perform. For example, one set of instructions may provide a slide-show interface allowing the user to select a series of pictures for sequential or random display, each for a period of time on the display. Any of a number of prompts and/or menus can be utilized to provide such control functionality. In one embodiment, internal non-volatile memory may be included to allow a user to store media within the display device. In addition, plug-in non-volatile memory interfaces may be included to allow the user to utilize well know formats of non-volatile memory such as Compact Flash or Secure Digital card memory to interface with the control circuitry. Controls interfacing with the circuitry allow the user to control the presentation of various media in the display screen. In this way, photos or images downloaded from a digital camera, the Internet, computer or other device can be stored on a given format, for example TIFF, PDF, JPG, etc. and displayed on display face.

In one embodiment, a user interface is displayed in the display area of LCD 210 on its front face. The interface provides a user various options for displaying media, including determining the source of the media, the order of the media display, and whether music accompanies the display, for example.

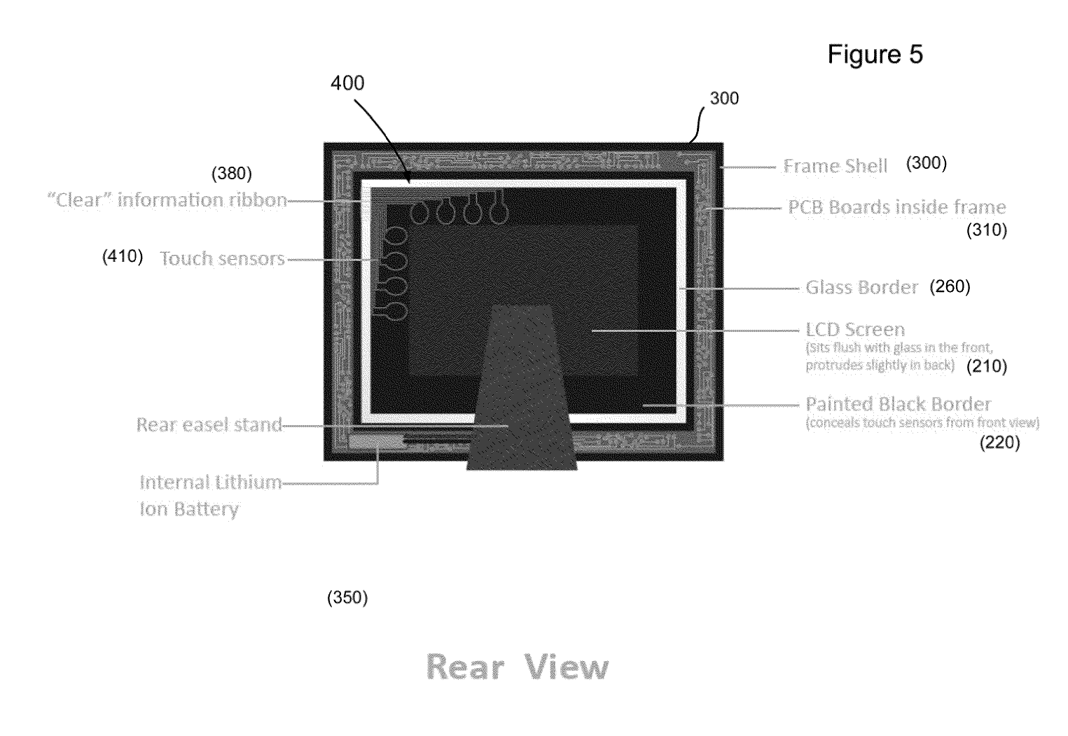

A touch sensitive control area 400 is provided within the black glass area 350, but (in some embodiments) not the display area of the display apparatus 100. The area allows a user to control the media display in a manner such as that disclosed in co-pending application Ser. No. 11/963,404, incorporated herein by referenced in its entirety. In accordance with the technology, the control area 400 does not enter the picture display area but rather is limited to the mat area. As illustrated in FIG. 5, a plurality of sensors 410, coupled via the information ribbon, provide the touch sensitive control. The sensors are provided on the back portion of the black glass 250 but are sensitive to finger pressure and touches on the front face of glass portion 220. In one embodiment, the sensors are IR sensors.

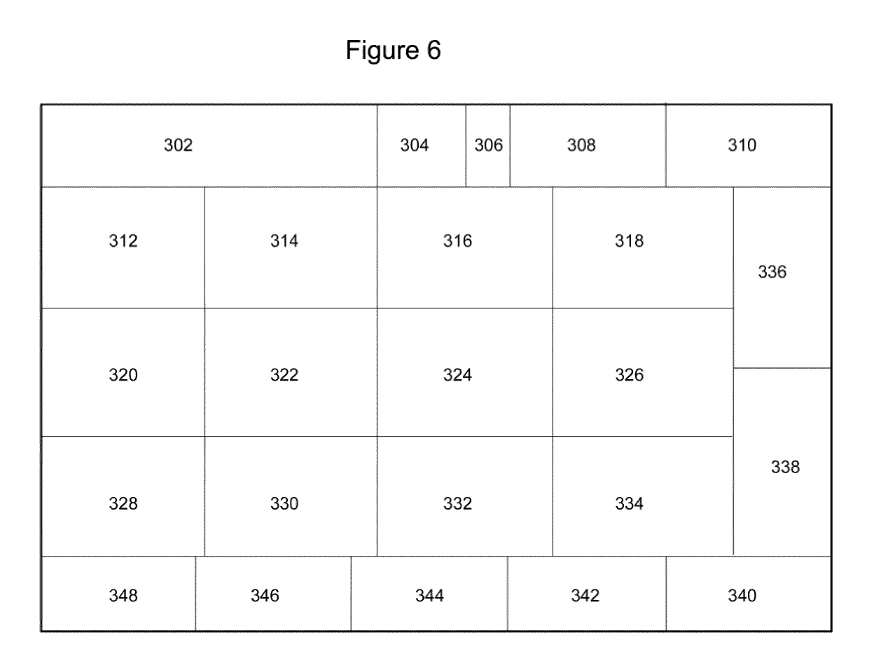

In another embodiment, glass border 215 will be made from ITO glass, which has the touch sensors embedded in the glass. In one implementation, glass border 215 will both surround and cover LCD display 210 so that LCD Display 210 will be positioned behind the glass. In such an arrangement, part of the touch sensitive user interface can be in front of LCD display 210. For example, FIG. 6 shows a glass panel that can serve as the glass border. The glass panel of FIG. 6 will be positioned in front of the LCD display 210. In one implementation, the portion of the glass panel that surrounds LCD display 210 will have a black section and a clear section, as described above to provide the “floating” effect. The glass panel is ITO glass with touch sensors embedded in the glass. The glass panel is divided into twenty four sections: 302, 304, 306, 308, 310, 312, 314, 316, 318, 320, 322, 324, 326, 328, 330, 332, 334, 336, 338, 340, 342, 344, 346, and 348. The sensors embedded in the glass have connects to communicate signals to the information carrying conductor ribbon 350, which is connected to the electronics described above.

In one example implementation, sections 312-334 are used to make media and large or scalable multi-choice selections, sections 336 and 338 are used to scroll, sections 340-348 are used as buttons for functions related to the media selected, and sections 302-310 are used for titles, media navigation, media selection and setup buttons.

It will be understood that numerous variations on the apparatus may be provided. For example, the black border may be provided by painting, coating or any type of coating technology. The border may be comprised of a material other than glass provided between the clear portion and the LCD. A material other than glass may be used to surround the LCD frame. The fame apparatus may be comprised of wood, plastic, or numerous other materials.

The PCB 310 and associated circuitry may be located in the frame, as illustrated, or may be positioned on the back of the LCD panel. The PCB 310 is illustrated as occupying the entire frame surrounding the display area, but in alternative embodiments may occupy only portions of the frame.

One embodiment includes a glass frame surrounding the LCD between the LCD and a frame. The glass frame having an opaque portion and a clear portion. The LCD display has an image display region and is provided in a display housing. The housing has a front portion and a rear portion.

One embodiment includes a LCD display having a front surface, electrical components that are connected to the LCD to provide images on the LCD, a glass border surrounding the LCD display, and a frame surrounding the LCD display and the glass border. The LCD display is mounted such that the front surface of the LCD display is flush with a front surface of the glass border. A first portion of the glass border is opaque in order to conceal the electrical components. A second portion of the glass border is clear. The second portion of the glass border surrounds the first portion of the glass border to provide a visual effect of the LCD and the second portion floating within the digital media apparatus.

In one example, the first portion the glass border is provided with a dark finish to make it opaque.

In one example, the apparatus further comprises touch sensitive sensors on a back portion of the glass border. The touch sensitive sensors are connected to the electrical components and provide a user interface.

In one example, the electrical components are provided in the frame.

Another embodiment includes a LCD display, electrical components that are connected to the LCD to provide images on the LCD display, a glass panel made of ITO glass surrounding and in front of the LCD display, and a frame surrounding the LCD display and the glass panel. A first portion of the glass panel is opaque in order to conceal the electrical components. A second portion of the glass panel is clear. The second portion of the glass panel surrounds the first portion of the glass panel to provide a visual effect of the LCD and the second portion floating within the digital media apparatus.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A digital media apparatus, comprising:
an LCD display having an image display region and being provided in a display housing, the housing having a front portion and a rear portion;
a glass frame surrounding the LCD between the LCD and a frame, the glass having an opaque portion and a clear portion.

2. A digital media apparatus, comprising:
a LCD display having a front surface;
electrical components, connected to the LCD, to provide images on the LCD;
a glass border surrounding the LCD display, the LCD display is mounted such that the front surface of the LCD display is flush with a front surface of the glass border, a first portion of the glass border is opaque in order to conceal the electrical components, a second portion of the glass border is clear, the second portion of the glass border surrounds the first portion of the glass border to provide a visual effect of the LCD and the second portion floating within the digital media apparatus; and
a frame surrounding the LCD display and the glass border.

3. The digital media apparatus of claim 2, wherein:
the first portion the glass border is provided with a dark finish to make it opaque.

4. The digital media apparatus of claim 2, further comprising:
touch sensitive sensors on a back portion of the glass border, the touch sensitive sensors are connected to the electrical components and provide a user interface.

5. The digital media apparatus of claim 2, wherein:
the electrical components are provided in the frame.

6. A digital media apparatus, comprising:
a LCD display;
electrical components, connected to the LCD, to provide images on the LCD;
a glass panel made of ITO glass surrounding and in front of the LCD display, a first portion of the glass panel is opaque in order to conceal the electrical components, a second portion of the glass panel is clear, the second portion of the glass panel surrounds the first portion of the glass panel to provide a visual effect of the LCD and the second portion floating within the digital media apparatus; and
a frame surrounding the LCD display and the glass panel.
